(19) United States
(12) Patent Application Publication
(10) Pub. No.: US 2010/0264941 A1
(43) Pub. Date: Oct. 21, 2010

(54) Method and Device for the Operation of an Mox Gas Sensor

(75) Inventors: Thomas Becker, Ottobrunn (DE); Ilker Sayhan, Munich (DE); Jordi Sabater, Munich (DE)

Correspondence Address: CROWELL & MORING LLP;INTELLECTUAL PROPERTY GROUP, P.O. BOX 14300, WASHINGTON, DC, 20044-4300, US

(73) Assignee: EADS DEUTSCHLAND Gmbh, Ottobrunn (DE)

(21) Appl. No.: 12/302,757

(22) PCT Filed: May 8, 2007
(86) PCT No.: PCT/DE2007/000819

§ 371 Date: Jun. 24, 2010

(30) Foreign Application Priority Data
May 29, 2006 (DE) 10 2006 025 249.7

(51) Int. Cl. G01N 27/00; G01N 27/04

(52) U.S. Cl. 324/693; 324/71.1

(57) ABSTRACT

A method for operating an MOX gas sensor is provided for measuring a gas concentration present in the environment. The MOX sensor is heated by an electric current source, and an electric output quantity of the sensor representing a gas concentration being detected and analyzed is generated. The MOX sensor is discontinuously heated at discrete measuring times by the electric current source, and a measured value representing the gas concentration is generated from the electric output quantity of the sensor detected during the discrete measuring times. A device for operating the MOX gas sensor is additionally is provided.

### RELATED APPLICATIONS

This application is a U.S. National Stage under 35 U.S.C. §371 of International Patent application no. PCT/DE2007/000819, filed on May 8, 2007, which claims priority to German Patent application no. DE 10 2006 025 249.7, filed May 29, 2006, the disclosures of each of which are incorporated by reference herein in their entireties

### BACKGROUND AND SUMMARY OF THE INVENTION

The invention relates to a method and a device for operating an MOX gas sensor. MOX gas sensors are used for measuring gas concentrations present in the environment of the sensor. The function of the MOX sensor is based on an analysis of the resistance or conductivity of a metal oxide layer (MOX) which is provided on a substrate that can be heated. Conventionally, such MOX sensors are continuously heated, which requires a high expenditure of energy. As a result, it is not possible to provide MOX sensors in battery-operated systems with a battery that only has a low capacity.

One object of certain embodiments of the invention is to provide a method and a device for operating an MOX gas sensor which requires only low heating energy.

The invention provides a method of operating an MOX gas sensor which is provided for measuring a gas concentration present in the environment. The MOX sensor is heated by an electric current source, and an electric output quantity of the MOX sensor representing the gas concentration is detected and analyzed. According to one aspect of the invention, the MOX sensor is discontinuously heated at discrete measuring times by the electric current source, and a measured value representing the gas concentration is generated from the electric output quantity of the sensor detected during the discrete measuring times.

According to another embodiment of the invention, an average value is generated from the electric output quantity detected during the discrete measuring times.

In another embodiment of the invention, the measured value representing the gas concentration is generated from the electric output quantity of the MOX sensor in each case detected during parts of the discrete measuring times.

In yet another embodiment of the invention, the electric output quantity may, in each case, be detected during parts of the discrete measuring times during which the electric output quantity is essentially constant.

In yet another embodiment of the invention, the resistance or conductivity of the MOX sensor is detected as the electric output quantity.

In still another embodiment of the invention, the voltage or current at the MOX sensor is detected as the electric output quantity.

In another embodiment of the invention, the gas concentration of ammonia in the environment of the gas sensor can be measured.

In still another embodiment of the invention, the gas concentration of ethene in the environment of the gas sensor is measured.

In additional embodiments of the invention, the gas concentrations of many additional gases, such as NO, NO2, CO, etc., are measured.

The method of the various embodiments is implemented by a battery-operated device.

According to another embodiment of the invention, the method can be implemented by a battery-operated device that is provided on an RFID Tag.

A device is provided for operating an MOX gas sensor provided for measuring a gas concentration present in the environment, comprising an electric current source for heating the gas sensor and a measuring apparatus for detecting and analyzing an electric output quantity of the gas sensor representing the gas concentration. According to the invention, the electric current source is provided for the discontinuous heating of the MOX sensor at discrete measuring times, and the measuring apparatus is provided for generating a measured value representing the gas concentration from the electric output quantity of the sensor detected during the discrete measuring times.

According to one embodiment of the invention, an average value from the electric output quantity detected during the discrete measuring times is generated by the device.

According to another embodiment of the invention, a measured value representing the gas concentration from the electric output quantity of the MOX sensor detected, in each case, during parts of the discrete measuring times is provided by the device.

In another embodiment of the invention, the device detects the electric output quantity in each case during parts of the discrete measuring times during which the electric output quantity is essentially constant.

In another embodiment of the invention, the device detects the resistance or the conductivity of the MOX sensor as the electric output quantity.

In another embodiment of the invention, the device detects the voltage or current at the MOX sensor as the electric output quantity.

In another embodiment of the invention, the device measures the gas concentration of ammonia in the environment of the gas sensor.

In another embodiment of the invention, the device measures the gas concentration of ethene in the environment of the gas sensor.

In yet another embodiment of the invention, the device is battery operated.

In still another embodiment of the invention, the device is battery operated and provided on an RFID Tag.

Other objects, advantages and novel features of the present invention will become apparent from the following detailed description of the invention when considered in conjunction with the accompanying drawings.

### BRIEF DESCRIPTION OF THE DRAWINGS

FIG. 1 is a diagram of a device for operating a MOX gas sensor according to an embodiment of the invention;

FIG. 2 is a diagram showing the resistance measured at the MOX sensor during the continuous operation and during the operation according to an embodiment of the invention;

FIGS. 3a and 3b are detailed views of the area of the measuring curve marked by a circle in FIG. 2 for the measurement of ammonia or ethene;

FIG. 4 and FIG. 5, respectively, are diagrams depicting the measurement of ammonia or ethane, according to certain embodiments of the invention.

### DETAILED DESCRIPTION OF THE DRAWINGS

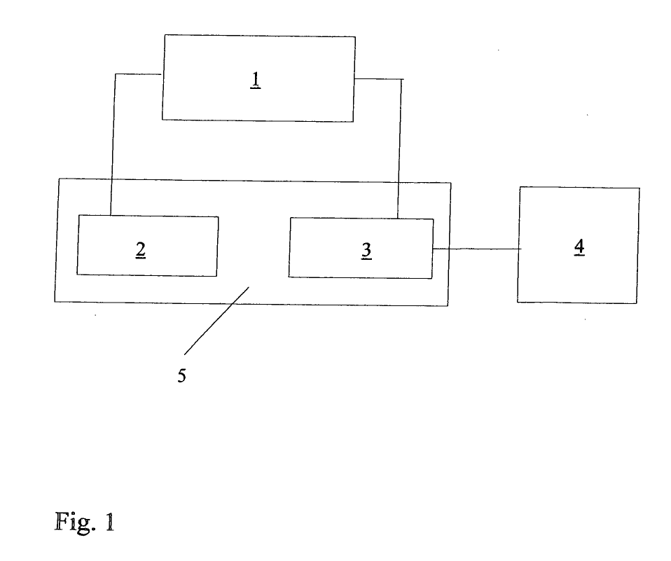

FIG. 1 is a simplified block diagram of a device provided for operating an MOX gas sensor 1.

The MOX sensor 1 is used for measuring a gas concentration present in the environment, such as ammonia or ethene, as may be required in the case of food transports. The MOX sensor 1 is heated by an electric current source 2. A measuring apparatus 3, 4 is used for detecting and analyzing an electric output quantity of the gas sensor 1 which represents the gas concentration. Depending on the measuring method used, this electric output quantity may, for example, be a voltage or current measurement, or, the measurement of a resistance or conductivity at the MOX sensor 1. The measuring apparatus 3, 4 comprises: a measuring part 3 which, in the illustrated embodiment, is provided in a sensor driver 5 together with the current source 2 and directly detects the above-mentioned electric output quantity of the sensor 1; and, an analyzing circuit 4 that is connected with the measuring part 3 and can be formed, for example, by a microcontroller or a computer. The current source 2 provided in the sensor driver 5 is constructed or controlled such that the MOX sensor 1 is discontinuously heated at discrete measuring times. The measuring apparatus 3, 4 is constructed such that generally a measured value representing the gas concentration is generated from the electric output quantity of the sensor 1 detected during these discrete measuring times.

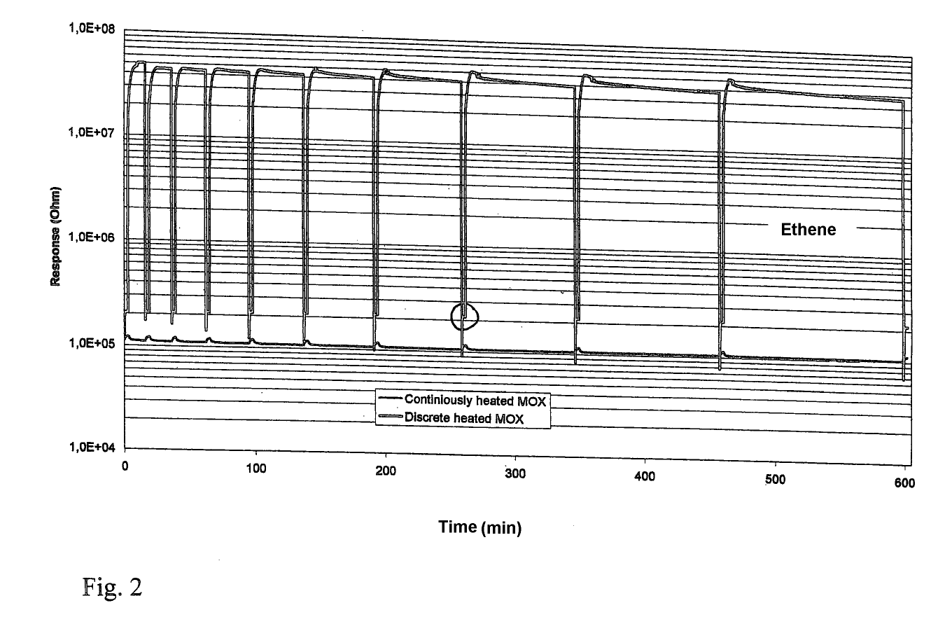

In the upper discontinuous curve, FIG. 2 shows the measuring of a predefined ethene concentration by discontinuous measurements at discrete measuring times compared with a continuous measurement as carried out conventionally and illustrated in the lower part of the diagram. As illustrated by the curve of the discontinuous measurement, at times of discontinuous heating of the MOX sensor 1, a sudden reduction of the resistance of the MOX sensor 1 occurs, which reduction amounts to more than two magnitudes.

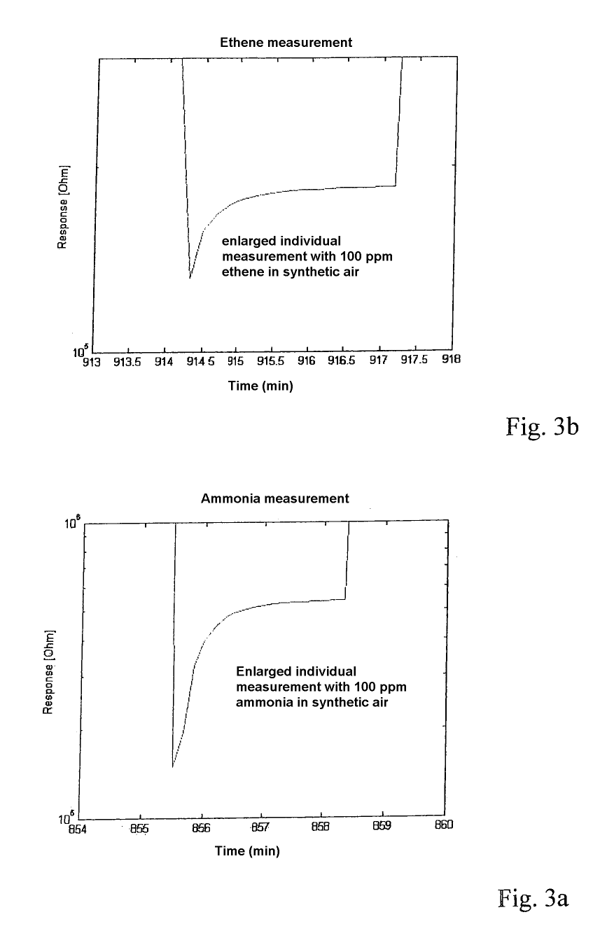

FIGS. 3a and b are enlarged views of the area indicated by a circle in the diagram of FIG. 2 illustrating the discontinuous measurement in the case of an ammonia concentration of 100 ppm in synthetic air or in the case of an ethene concentration of 100 ppm in synthetic air. It is illustrated that, at the beginning of the discrete measurement, an overswinging of the measuring curve in the form of a peak first takes place at the falling edge, which then levels out to an essentially constant value. A comparison of the measuring curve for the discontinuous measurement and of the measuring curve for the continuous measurement in FIG. 2 shows that the steady-state, almost constant measured value is above the measured value of the continuous measurement; thus, the resistance does not completely fall to the value of the continuous measurement.

The measured value representing the gas concentration is generated from the electric output quantity, in each case, detected during parts of the discrete measuring times—in the embodiment described here. The resistance of the MOX sensor 1 may be an average of these values.

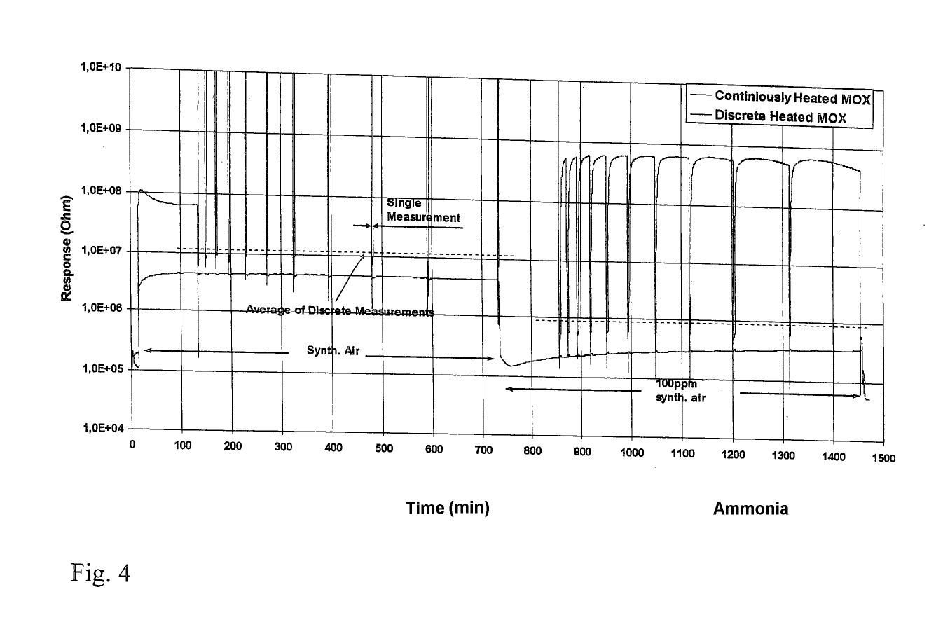

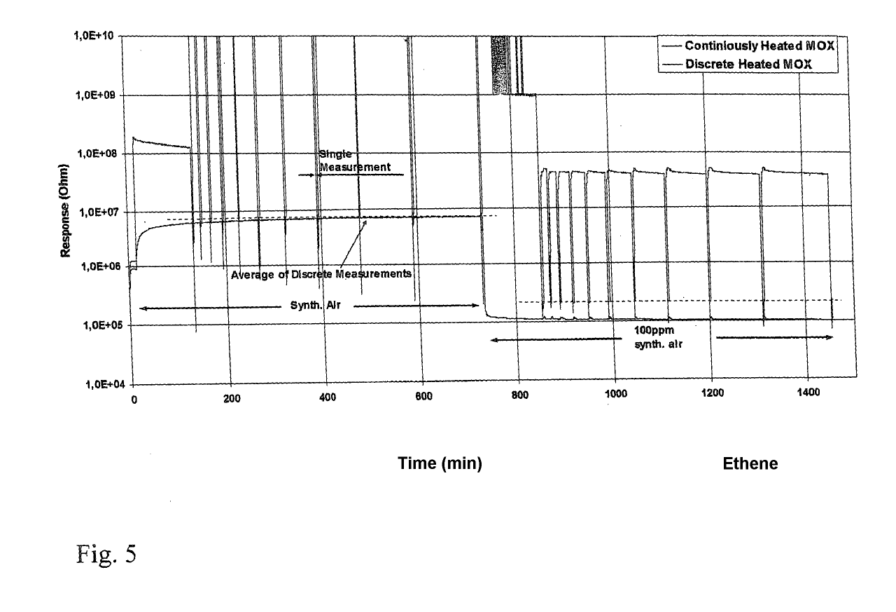

FIG. 4 and FIG. 5 illustrate the discontinuous measurements, the average values obtained therefrom and the measured values conventionally obtained during continuous measurements. The left part of the figures shows the measurements for pure synthetic air. The right part of the figures shows the measurement for concentrations of 100 ppm ammonia (FIG. 4) or 100 ppm ethene (FIG. 5). The figures show for both cases a falling of the resistance by approximately one magnitude for the conventional continuous measurement. As indicated by the entered average values, the discrete measurements follow the continuous measurements, although they are displaced in the upward direction; i.e., the average value of the discrete measurements also shows a similar falling by approximately one magnitude. As a result, a reliable detection of the gas concentrations becomes possible.

Instead of the electric resistance, the conductivity, the voltage or the current at the MOX sensor 1 can be detected.

The measurement can also take place in the battery operation by means of low-capacity batteries. As a result, it becomes possible, for example, to provide the device used for the measuring on an RFID Tag (radio frequency identification). Such RFID Tags are increasingly used in merchandise logistics, such as food transport or for the transport of other perishable goods or in other fields. This is advantageous for all purposes where the monitoring of also low gas concentrations is important.

The entire measuring device can be provided in the form of an integrated circuit on a chip.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMBERS

1 MOX sensor
2 Current source
3 Measuring circuit
4 Microcontroller
5 Sensor driver

1-20. (canceled)

21. A method of operating an MOX gas sensor, the MOX gas sensor being provided for measuring a gas concentration, the method comprising:
heating the MOX gas sensor with an electric current source, and
detecting and analyzing the electric output quantity of the MOX sensor which is representative of the gas concentration, wherein
the MOX sensor is discontinuously heated at discrete measuring times by the electric current source, and
generating a measured value representing the gas concentration from the electric output quantity of the sensor detected during the discrete measuring times.

22. The method according to claim 21, further comprising an average value is generated from the output quantity detected during the discrete measuring times.

23. The method according to claim 21, wherein the measured value representing the gas concentration is generated from the electric output quantity of the MOX sensor in each result detected during parts of the discrete measuring times.

24. The method according to claim 23, wherein the electric output quantity in each result is detected during parts of the discrete measuring times during which the electric output quantity is essentially constant.

25. The method according to claim 21, wherein resistance or conductivity of the MOX sensor is detected as the electric output quantity.

26. The method according to claim 21, wherein the electric output is voltage or current at the MOX sensor.

27. The method according to claim 21, wherein the gas concentration of ammonia is measured.

28. The method according to claim 21, wherein the gas concentration of ethene is measured.

29. The method according to claim 21, wherein the method is implemented by a battery-operated device.

30. The method according to claim 29, wherein the method is implemented by a battery-operated device which is provided on an RFID Tag.

31. A device for operating an MOX gas sensor provided for measuring a gas concentration, comprising:
an electric current source for heating the gas sensor;
a measuring apparatus for detecting and analyzing an electric output quantity of the gas sensor representing the gas concentration, wherein
the electric current source is configured to provide discontinuous heating of the MOX sensor at discrete measuring times, and
the measuring apparatus is configured to provide a measured value representing the gas concentration from the electric output quantity of the sensor in each result detected during the discrete measuring times.

32. The device according to claim 31, wherein the measuring apparatus is configured to generate an average value from the electric output quantity in each result detected during the discrete measuring times.

33. The device according to claim 31, wherein the measuring apparatus is configured to generate the measured value representing the gas concentration from the electric output quantity of the MOX sensor in each result detected during parts of the discrete measuring times.

34. The device according to claim 33, wherein the measuring apparatus is configured to detect the electric output quantity in each result during parts of the discrete measuring times during which the electric output quantity is essentially constant.

35. The device according to claim 31, wherein the measuring apparatus is configured to detect the at least one resistance or conductivity of the MOX sensor as the electric output quantity.

36. The device according to claim 31, wherein the measuring apparatus is configured to detect the voltage or current at the MOX sensor as the electric output quantity.

37. The device according to claim 31, wherein the device is configured to measure the gas concentration of ammonia in the environment of the gas sensor.

38. The device according to claim 31, wherein the device is configured to measure the gas concentration of ethene in the environment of the gas sensor.

39. The device according to claim 31, wherein the device is battery operated.

40. The device according to claim 39, wherein the device is battery operated and provided on an RFID Tag.
